(19) United States
(12) Patent Application Publication
(10) Pub. No.: US 2026/0025786 A1
(43) Pub. Date: Jan. 22, 2026

(54) TECHNIQUES FOR RESPONDING TO ENVIRONMENTAL STATE TRANSITIONS EXPERIENCED BY A WIRELESS DEVICE

(71) Applicant: Apple Inc., Cupertino, CA (US)

(72) Inventors: Lorenzo BERTIZZOLO, San Francisco, CA (US); Prashant H. VASHI, San Jose, CA (US); Ioannis PEFKIANAKIS, San Jose, CA (US)

(21) Appl. No.: 19/263,945

(22) Filed: Jul. 9, 2025

Related U.S. Application Data
(60) Provisional application No. 63/672,005, filed on Jul. 16, 2024.

(51) Int. Cl. H04W 64/00

(52) U.S. Cl. CPC H04W 64/00

(57) ABSTRACT

This Application sets forth techniques for responding to environmental state transitions experienced by a wireless device. One or more components of a wireless device can detect multiple environmental conditions and determine initiation of an environmental state transition, where an environmental state includes a predefined set of attributes. Determination of the initiation of the environmental state transition can include analysis of the multiple environmental conditions and the predefined set of attributes. Exemplary environmental state transitions include transitioning to being away from a train station, proximate to a train station, within a train station, on a train, and the like. In response to the environmental state transition, the one or more components of the wireless device can perform at least one action.

### CROSS-REFERENCE TO RELATED APPLICATIONS

The present application claims the benefit of U.S. Provisional Application No. 63/672,005, entitled “TECHNIQUES FOR RESPONDING TO ENVIRONMENTAL STATE TRANSITIONS EXPERIENCED BY A WIRELESS DEVICE,” filed Jul. 16, 2024, the content of which is incorporated by reference herein in its entirety for all purposes.

### FIELD

The described embodiments set forth techniques for responding to environmental state transitions experienced by a wireless device. In particular, the techniques enable a wireless device to analyze different environmental conditions to determine whether the wireless device is undergoing an environmental state transition, e.g., the wireless device transitioning to being away from a train station, proximate to a train station, within a train station, on a train, etc. In turn, the wireless device can perform at least one action in response to the environmental state transition.

### BACKGROUND

Smartphones face significant energy challenges when operating in public transportation systems, such as subway systems, due to the inconsistent availability of cellular and Wi-Fi connections. One issue involves the constant signal searching that occurs as smartphones move through different areas of the subway system. In particular, in tunnels and underground stations, signal strength can be weak or intermittent, which results in smartphones continuously scanning for available cellular and Wi-Fi networks. This perpetual scanning is a power-intensive process that expends battery life.

Frequent network switching is another problem that contributes to energy consumption. In particular, subways often have a mix of cellular coverage provided by distributed antenna systems (DAS) and Wi-Fi networks installed in train stations and trains. As smartphones move, they may detect stronger signals from different networks and attempt to switch connections. This handoff process involves complex procedures such as authentication, re-association, and Internet Protocol (IP) address management, all of which are energy-draining activities that may not necessarily result in establishing successful connections. The rapid movement, relocation, etc., of trains exacerbates this issue, as smartphones are faced with handling frequent and rapid transitions between different network sources.

Signal strength fluctuations within subway tunnels can further strain smartphone batteries. In particular, the concrete walls and metal reinforcements in subway tunnels can cause significant signal attenuation and reflection, thereby leading to variable signal strength. To maintain a connection, smartphones often increase their transmission power, which results in higher battery consumption. Additionally, modern smartphones are designed to operate across multiple frequency bands and support various technologies (e.g., 3G, 4G, 5G, and Wi-Fi). In this regard, in an underground environment where different parts of the subway system might be covered by different frequencies and technologies, smartphones' radio components typically remain active and responsive to all potential signals, which can further-increase energy use.

Additionally, background processes in smartphones can also contribute to battery drain when brought into subways. In particular, it is common for certain types of software applications e.g., navigation, messaging, and social media platforms—to require somewhat continuous connectivity for optimal functionality. In environments with sporadic connectivity, these software application may frequently attempt to reconnect and sync data, and thereby unnecessarily consume power.

In view of the foregoing considerations, there exists a need for improved techniques for managing the operation of wireless devices within subway systems.

### SUMMARY

The described embodiments set forth techniques for responding to environmental state transitions experienced by a wireless device. In particular, the techniques enable a wireless device to analyze different environmental conditions to determine whether the wireless device is undergoing an environmental state transition, e.g., the wireless device transitioning to being away from a train station, proximate to a train station, within a train station, on a train, etc. In turn, the wireless device can perform at least one action in response to the environmental state transition.

One embodiment sets forth a method for responding to environmental state transitions experienced by a wireless device. In some embodiments, the method can be implemented by one or more components of the wireless device by performing steps that include: i) detecting multiple environmental conditions; ii) determining initiation of an environmental state transition, where an environmental state includes a predefined set of attributes associated with a location, and determination of the initiation of the environmental state transition is based on analysis of the multiple environmental conditions and the predefined set of attributes; and iii) performing at least one action in response to the environmental state transition.

In some embodiments, a location includes a train station. In some embodiments, the predefined set of attributes include proximity information associated with the train station and/or with a train. In some embodiments, the multiple environmental conditions include two or more of: location information, altitude information, cellular signal information, motion information, payment transaction information, Wi-Fi signal information, or any combination thereof.

Other embodiments include a non-transitory computer readable medium configured to store instructions that, when executed by a processor included in a computing device, cause the computing device to implement the methods and techniques described in this disclosure. Yet other embodiments include hardware computing devices that include one or more processors that can be configured to cause the hardware computing devices to implement the methods and techniques described in this disclosure.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of particular components of a wireless device illustrated in FIG. 1, according to some embodiments.

FIG. 3 illustrates a conceptual diagram of a manner in which sensors of the wireless device of FIGS. 1 and 2 can be configured to analyze environmental conditions, according to some embodiments.

FIGS. 4A and 4B illustrate conceptual diagrams of an example scenario that involves a wireless device undergoing environmental state transitions, according to some embodiments.

FIGS. 5A and 5B illustrate exemplary methods for responding to environmental state transitions experienced by a wireless device, according to some embodiments.

FIG. 6 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The described embodiments set forth techniques for responding to environmental state transitions experienced by a wireless device. In particular, the techniques enable a wireless device to analyze different environmental conditions to determine whether the wireless device is undergoing an environmental state transition, e.g., the wireless device transitioning to being away from a subway station, proximate to a subway station, within a subway station, on a train, etc. In turn, the wireless device can perform at least one action in response to the environmental state transition.

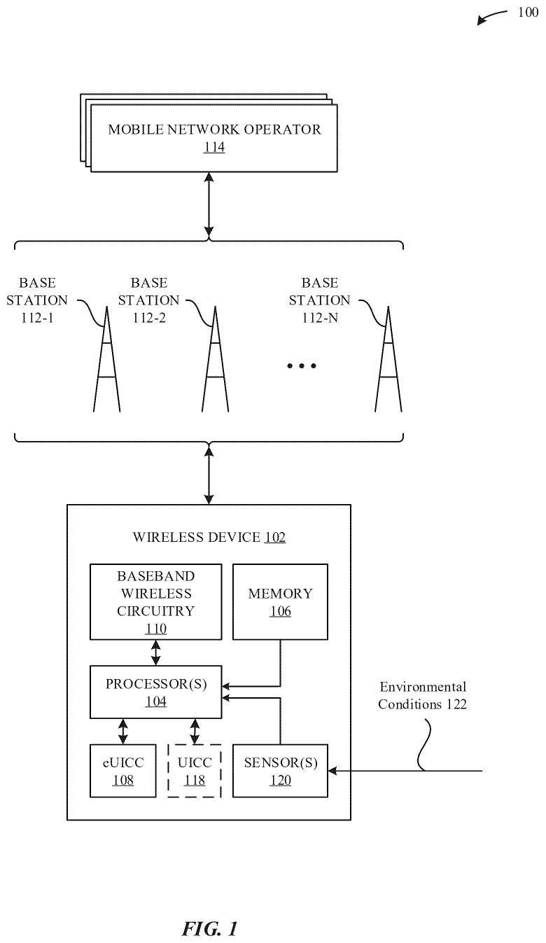

These and other embodiments are discussed below with reference to FIGS. 1-6; however, those skilled in the art will readily appreciate that the detailed description given herein with respect to these figures is for explanatory purposes only and should not be construed as limiting.

FIG. 1 illustrates a block diagram of different components of a system 100 that is configured to implement the various techniques described herein, according to some embodiments. More specifically, FIG. 1 illustrates a high-level overview of the system 100, which, as shown, includes a wireless device 102, which can also be referred to as a device, a wireless device, a mobile device, a user equipment (UE) and the like. Further, reference to actions performed by a wireless device 102 can be construed to include actions performed by the wireless device 102 as a whole and/or by one or more components (e.g., processors, modems, memory, etc.) of the wireless device 102. The system further includes a group of base stations 112-1 to 112-N, which are managed by different Mobile Network Operators (MNOs) 114. Additional MNO infrastructure servers, such as used for account management and billing are not shown. The wireless device 102 can represent a mobile computing device (e.g., an iPhone®, an iPad®, an Apple Watch by Apple®, etc.), the base stations 112-1 to 112-n can represent cellular radio access network (RAN) entities including fourth generation (4G) Long Term Evolution (LTE) evolved NodeBs (cNodeBs or eNBs), fifth generation (5G) NodeBs (gNodeBs or gNB), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUs)). The MNOs 114 can represent different wireless service providers that provide specific cellular wireless services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processor(s) 104 and a memory 106, at least one embedded Universal Integrated Circuit Card (cUICC) 108, and/or integrated UICC (iUICC) (not shown) and baseband wireless circuitry 110 used for transmission and reception of cellular wireless radio frequency signals. The baseband wireless circuitry 110 can include analog hardware components, such as antennas and amplifiers, as well as digital processing components, such as signal processors (and/or general/limited purpose processors) and associated memory. In some embodiments, the wireless device 102 includes one or more universal integrated circuit cards (UICCs) 118, also referred to as physical Subscriber Identity Module (SIM) cards, each eUICC 108 including a SIM, in addition to or in place of the eUICC 108 providing one or more electronic SIM (eSIM) profiles and/or an iUICC providing one or more eSIM profiles. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, cUICC 108, baseband wireless circuitry 110, and UICC 118) can be arranged and combined in any number of configurations.

The eUICC 108 can be configured to store multiple electronic SIM (eSIM) profiles for accessing cellular wireless services offered by one or more different MNOs 114 via communication through base stations 112-1 to 112-N. To be able to access services provided by the MNOs, one or more eSIM profiles can be provisioned to the eUICC 108 of the wireless device 102.

Additionally, and as shown in FIG. 1, the wireless device 102 can include one or more sensors 120 that are capable of analyzing environmental conditions 122. According to some embodiments, the sensors 120 can represent one or more of the components illustrated in FIG. 1, as well as components that are not specifically illustrated in FIG. 1. According to some embodiments, the sensors can represent hardware and/or software components that enable the wireless device 102 to detect and process the environmental conditions 122 in order to provide the functionalities described herein.

For example, the sensors 120 can enable the wireless device 102 to obtain location information associated with the wireless device 102, e.g., through at least one global navigation satellite system (GNSS) with which the wireless device 102 is capable of interfacing. According to some embodiments, the position can be provided to different mapping systems to obtain subway station locations that are proximate to the wireless device 102, a ground elevation relative to the position of the wireless device 102, and so on. In another example, the sensors 120 can enable the wireless device 102 to obtain altitude information associated with the wireless device 102, e.g., through at least one altimeter included on the wireless device 102. In another example, the sensors 120 can enable the wireless device 102 to obtain cellular signal information, e.g., through the baseband wireless circuitry 110. In another example, the sensors 120 can enable the wireless device 102 to obtain motion information associated with the wireless device 102, e.g., through at least one accelerometer included on the wireless device 102. In another example, the sensors 120 can enable the wireless device 102 to obtain payment transaction information associated with the wireless device, e.g., through at least one wireless payment system included on the wireless device 102. In yet another example, the sensors 120 can enable the wireless device 102 to obtain Wi-Fi signal information associated with the wireless device 102, e.g., through at least one Wi-Fi component included on the wireless device 102.

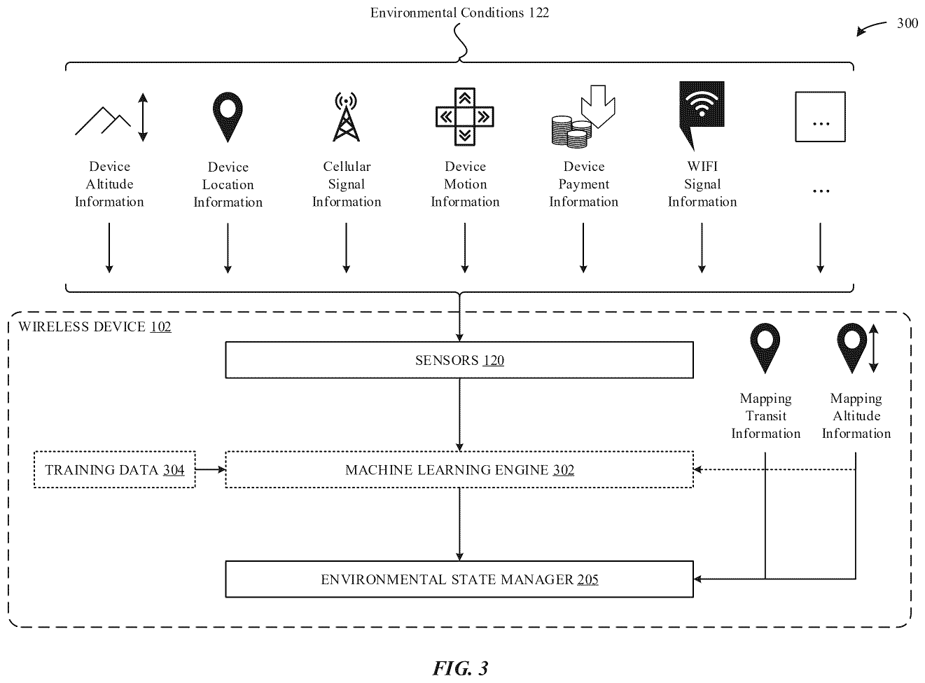

It is noted that the foregoing examples are not meant to be limiting, and that the wireless device 102 can include any number of hardware-based and/or software-based sensors 120, capable of detecting any amount, type, form, etc., of information, at any level of granularity, consistent with the scope of this disclosure. In any case, the wireless device 102 can utilize information gathered through the sensors 120 to identify different environmental states in which the wireless device 102 is disposed, e.g., away from a subway station, approaching a subway station, within a subway station, within a subway train, etc., as well as identifying when the wireless device 102 is transitioning between the different environment states. While the description herein refers to a subway system including subway stations that can be underground, the same ideas can be applied generally to a public transportation system that includes trains and train stations, where a wireless device 102 can encounter variable operating conditions. A more detailed explanation of the sensors 120 and the environmental conditions 122 is provided below in conjunction with FIG. 3.

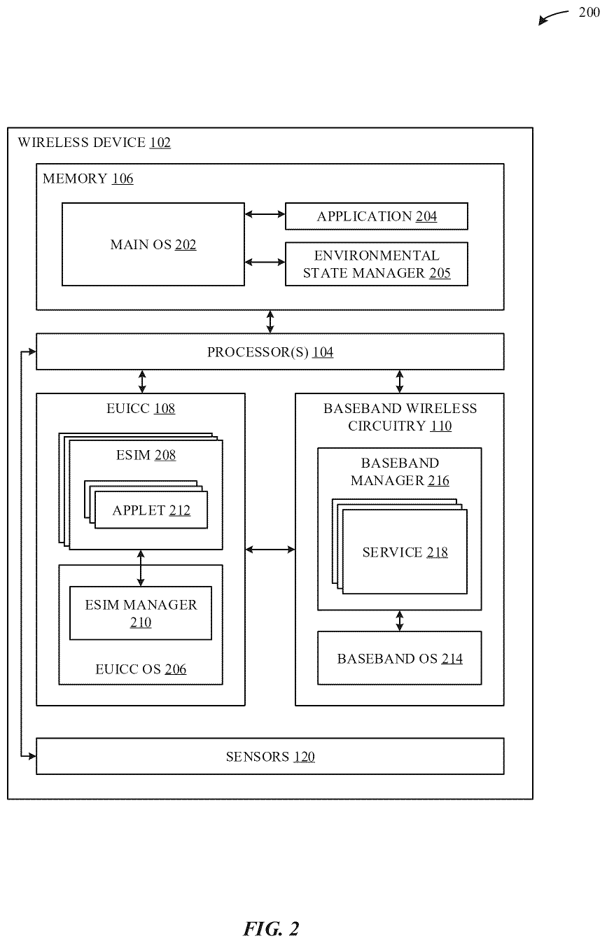

FIG. 2 illustrates a block diagram 200 of a more detailed view of exemplary components of the wireless device 102 of the system 100 of FIG. 1. The one or more processors 104, in conjunction with memory 106, can implement a main operating system (OS) 202 that is configured to execute applications 204 (e.g., native OS applications and user applications). The main OS 202 can also be configured to implement an environmental state manager 205 that is configured to detect a current environmental state within which the wireless device 102 is disposed, as well as transitions there between. A more detailed explanation of the environmental state manager 205 is provided below in conjunction with FIGS. 3, 4A-4B, and 5.

As shown in FIG. 2, the cUICC 108 can be configured to implement an eUICC OS 206 that can be configured to manage hardware resources of the eUICC 108 (e.g., a processor and a memory embedded in the eUICC 108). The eUICC OS 206 can also be configured to manage eSIM profiles 208 that are stored by the eUICC 108, e.g., by enabling, disabling, modifying, updating or otherwise performing management of the eSIM profiles 208 within the eUICC 108 and to provide baseband wireless circuitry 110 with access to the eSIM profiles 208 to provide access to wireless services for the wireless device 102. The eUICC 108 OS can include an eSIM profile manager 210, which can perform management functions for various eSIM profiles 208. According to the illustration shown in FIG. 2, each eSIM profile 208 can include a number of applets 212 that define the manner in which the eSIM profile 208 operates. For example, one or more of the applets 212, when implemented in conjunction with baseband wireless circuitry 110 and the cUICC 108, can be configured to enable the wireless device 102 to communicate with an MNO 114 and provide useful features (e.g., phone calls and internet access) to a user of the wireless device 102.

As also shown in FIG. 2, the baseband wireless circuitry 110 of the wireless device 102 can include a baseband OS 214 that is configured to manage hardware resources of the baseband wireless circuitry 110 (e.g., a processor, a memory, different radio components, etc.). The baseband component 110 (or a portion thereof) can also be referred to as a baseband component, a wireless baseband component, a baseband wireless processor, a cellular baseband component, a cellular component, and the like. According to some embodiments, the baseband wireless circuitry 110 can implement a baseband manager 216 that is configured to interface with the eUICC 108 to establish a secure channel with an MNO provisioning server and obtain information (such as eSIM profile data) from the MNO provisioning server for purposes of managing eSIM profiles 208. The baseband manager 216 can be configured to implement services 218, which represents a collection of software modules that are instantiated by way of the various applets 212 of enabled eSIM profiles 208 that are included in the eUICC 108. For example, services 218 can be configured to manage different connections between the wireless device 102 and MNOs 114 according to the different eSIM profiles 208 that are enabled within the eUICC 108. In some embodiments, a processor 104 of the wireless device 102 and/or the cUICC 108 can include a local profile assistance (LPA) module to assist with management of eSIM profiles 208 on the eUICC 108 of the wireless device 102.

FIG. 3 illustrates a conceptual diagram 300 of a manner in which the sensors 120 of the wireless device 102 can be configured to obtain, analyze, etc., environmental conditions 122, according to some embodiments. As shown in FIG. the environmental conditions 122 can relate to altitude information, location information, cellular signal information, motion information, payment information, Wi-Fi information, and the like. As previously described herein, the environmental conditions 122 illustrated in FIG. 3 should not be construed as limiting, and can represent any amount, type, form, etc., of information, at any level of granularity, consistent with the scope of this disclosure.

As previously discussed herein, each sensor 120 can represent hardware and/or software components implemented on the wireless device 102. According to some embodiments, each sensor 120 can be configured to analyze specific environmental conditions 122 and to output raw and/or processed information. In particular, the processed information can constitute an abstraction of the raw data that can provide useful information, reduce post-processing burdens, and so on. For example, a motion sensor 120 can determine, based on the raw data it collects, that a particular activity (e.g., walking, going up/down a staircase/escalator/elevator, etc., being on a train, etc.) is taking place. It is noted that the foregoing example is not meant to be limiting, and that any number of sensors 120 can be configured to provide raw/processed information, at any level of granularity, consistent with the scope of this disclosure.

According to some embodiments, a sensor 120 configured to analyze an altitude of the wireless device 102 can output elevation, rate of ascent/descent, pressure, temperature, etc., information (and/or information abstracted therefrom). According to some embodiments, a sensor 120 configured to analyze a location of the wireless device 102 can output latitude and longitude, altitude, time, speed, direction (heading), distance to destination, estimated time of arrival (ETA), course over ground (COG), number of satellites, etc., information (and/or information abstracted therefrom). According to some embodiments, a sensor 120 configured to analyze cellular signal information can be configured to output signal strength, signal quality, cell identifier, frequency band, network type, data rate, call status, connectivity status, location, power level, handover, error rate, etc., information (and/or information abstracted therefrom). According to some embodiments, a sensor 120 configured to analyze motion of the wireless device 102 can output acceleration, orientation, vibration, shock, free fall, etc., information (and/or information abstracted therefrom). According to some embodiments, a sensor 120 configured to analyze payment information associated with the wireless device 102 can output transaction ID, amount, currency, date and time, payer, payee, payment method, transaction status, reference number, merchant information, authorization code, description, fees, exchange rate, etc., information (and/or information abstracted therefrom). According to some embodiments, a sensor 120 configured to analyze Wi-Fi signal information can output signal strength, signal quality, service set identifier (SSD), basic service set identifier (BSSID), frequency band, channel, data rate, connection status, security type, Internet Protocol (IP) address, media access control (MAC) address, packet loss, latency, noise level, etc., information (and/or information abstracted therefrom).

As shown in FIG. 3, the sensors 120 can be configured to output information (e.g., raw information, processed information, abstracted information, etc.) to an optional machine learning engine 302 that is implemented on the wireless device 102. According to some embodiments, the machine learning engine 302 can be configured based on training data 304 (e.g., gathered by other wireless devices placed into the same or similar scenarios described herein, gathered through simulated events, etc.) that enables the machine learning engine 302 to generate useful information based on what is gathered by the sensors 120. The useful information can include, for example, identifying when the wireless device 102 is away from a subway station, proximate to a subway station, within a subway station, on a train, etc., is transitioning therebetween, etc. It is noted that the foregoing examples are not meant to be limiting, and that the machine learning engine 302 can be configured to generate any useful information—at any level of granularity—without departing from the scope of this disclosure. It is also noted that the environmental state manager 205 can be configured to identify—independently, or with the assistance of the machine learning engine 302—when the wireless device 102 is away from a subway station, proximate to a subway station, within a subway station, on a train, etc., is transitioning therebetween, etc., using any approach, such as machine-learning approaches, rule-based approaches, etc. As described in greater detail below, the environmental state manager 205 can be configured to perform different actions in response to transitioning between different environmental states, remaining within different environmental states (e.g., for threshold periods of time), etc.

It is noted that the foregoing environmental conditions 122, as well as the foregoing example manners in which they can be analyzed by the machine learning engine 302/environmental state manager 205, are not meant to be limiting. On the contrary, the machine learning engine 302/environmental state manager 205 can be configured to analyze any number of environmental conditions 122—as well as any amount, type, form, etc., of other information—in any fashion to effectively identify the different environmental states of the wireless device 102, consistent with the scope of this disclosure. For example, as shown in FIG. 3, the device location information can be referenced against mapping transit information to identify a subway station that is closest to the wireless device 102. In another example, the device location information can be referenced against mapping altitude information to identify a ground level elevation of a current position of the wireless device 102. As described below, the ground level elevation can compared against the device altitude information to more accurately determine whether the wireless device 102 is above ground or below ground at its current location.

In another example, if a user of the wireless device 102 has granted the wireless device 102 permission to access the user's calendar information, then the wireless device 102 could analyze such calendar information to determine, at least in part, the different states of the wireless device 102 discussed herein. For example, if a calendar entry indicates a subway transit time from 3:30 PM-4 PM, and the current time is within that range, then the machine learning engine 302/environmental state manager 205 could incorporate such information into determining the environmental state. In another example, a user of the wireless device 102 can grant permission to analyze the user's current/past activities. In this regard, the wireless device 102 could effectively determine, based on past activities, that a current activity suggests the user (in possession of the wireless device 102) may be away from a subway station, proximate to a subway station, within a subway station, on a train, etc. Again, it is noted that these examples are not meant to be limiting, and that the wireless device 102 can utilize any approach for effectively identifying the various states/activities discussed herein.

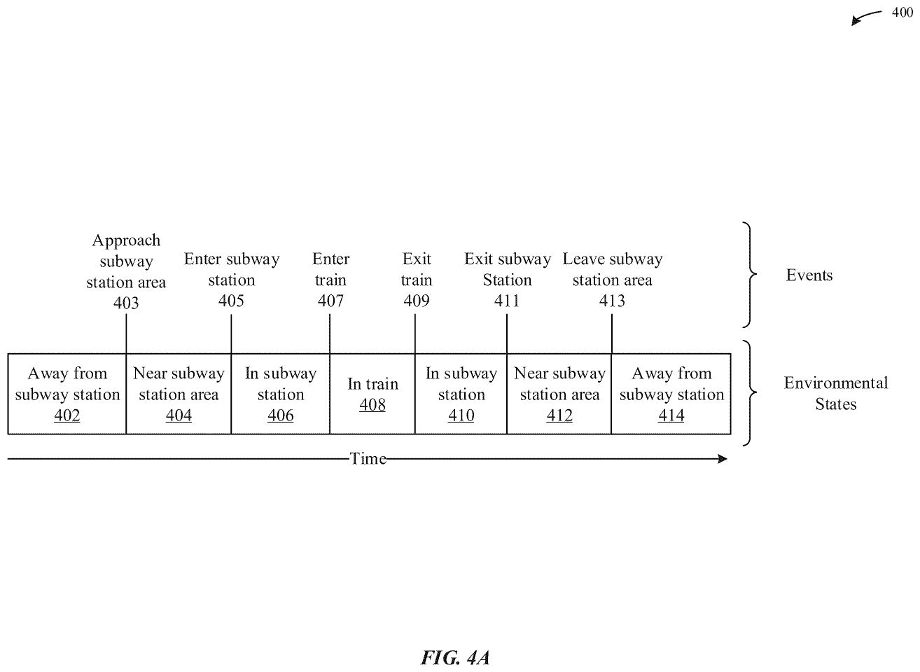

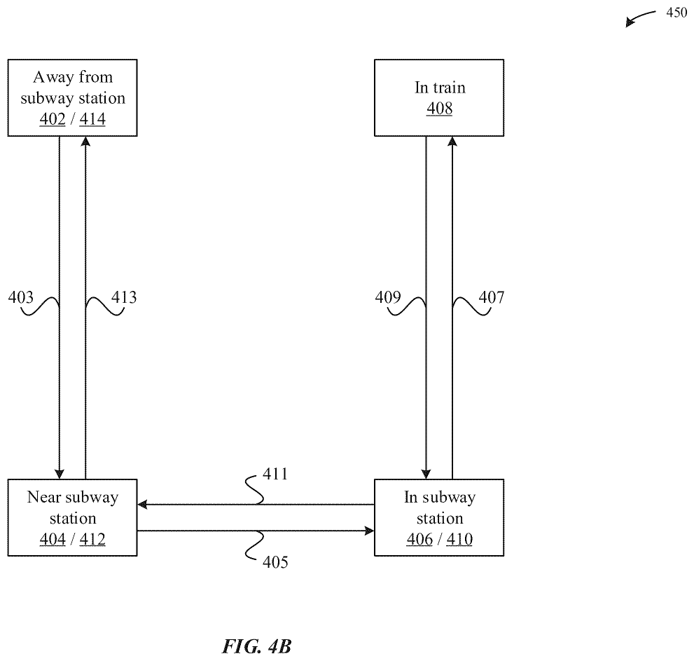

FIGS. 4A-4B illustrate conceptual diagrams 400, 450 of an example scenario that involves a wireless device 102 undergoing environmental state transitions, according to some embodiments. As described herein, the wireless device 102 can access (1) location information associated with the wireless device 102, where the location information includes (i) a position of the wireless device 102 obtained through at least one global navigation satellite system (GNSS), (ii) mapping-based transit information that identifies subway station locations relative to the position of the wireless device 102, (iii) mapping-based elevation information that identifies a ground elevation relative to the position of the wireless device 102, or (iv) any combination thereof. According to some embodiments, an accuracy rating of the position can be based on a horizontal dilution of precision (HDOP), a vertical dilution of precision (VDOP), a position dilution of precision (PDOP), an estimated position error (EPE), a number of satellites, a signal-to-noise ratio (SNR), or any combination thereof. According to some embodiments, the wireless device 102 can also access (2) altitude information associated with the wireless device 102, (3) cellular signal information observed by the wireless device 102, (4) motion information observed by the wireless device 102, (5) payment transaction information observed by the wireless device 102, (6) Wi-Fi signal information observed by the wireless device 102, or (7) any combination thereof.

As shown in FIG. 4A, an environmental state 402 can involve the wireless device 102 being away from a subway station. According to some embodiments, the wireless device 102 can identify the environmental state 402 by (1) determining that the aforementioned accuracy rating of the position satisfies a threshold level, and (2) determining, based on the position and the mapping-based transit information, that the wireless device 102 is within a threshold distance from a closest subway station. According to some embodiments, the accuracy rating for the position can be calculated by evaluating factors such as the number of satellites in view, signal strength, dilution of precision (DOP) values, potential error sources like atmospheric conditions and multipath interference, the type of positioning method used (such as differential GPS or assisted GPS), algorithmic corrections, etc., all of which can collectively be used to estimate a radius within which the true position likely resides. In this regard, the threshold level can be static (or dynamic) in nature, where the accuracy rating must meet or exceed the threshold level. According to some embodiments, the threshold distance can be static in value, e.g., thirty feet. The threshold distance can also be dynamic in value. For example, the threshold distance can be decreased when the wireless device 102 is located in an area that has a high concentration/number of subway stations (e.g., Tokyo), and the threshold distance can be increased when the wireless device 102 is located in an area that has a low concentration/number of subway stations (e.g., rural areas).

As shown in FIG. 4A, an event 403 involves the wireless device 102 approaching a subway station area, which ultimately results in an environmental state 404 where the wireless device 102 is near a subway station area. According to some embodiments, the wireless device 102 can identify the environmental state 404 by (1) determining that the accuracy rating of the position satisfies a threshold level (e.g., at least seventy-five percent, points, etc.), and (2) determining, based on the position and the mapping-based transit information, that the wireless device 102 is within a threshold distance to a closest subway station (e.g., thirty feet).

As shown in FIG. 4A, an event 405 involves the wireless device 102 entering into a subway station, which ultimately results in an environmental state 406 where the wireless device 102 is within a subway station. According to some embodiments, the wireless device 102 can identify the environmental state 406 by (1) determining, based on the altitude information and the ground elevation, that the wireless device is disposed lower than the ground elevation (e.g., by a threshold value). For example, if the ground elevation is four hundred feet, and the altitude information indicates the wireless device 102 is at three hundred ninety feet, then the wireless device 102 can determine, at least to a reliable degree, that it is underground. It is noted that the foregoing example is not meant to be limiting, and that the wireless device 102 can be configured to analyze any amount, type, form, etc., of location information, at any level of granularity, to effectively identify whether the wireless device 102 is above or below ground, consistent with the scope of this disclosure.

The wireless device 102 can also identify the environmental state 406 by (2)(i) determining, based on the location information, that at least one signal associated with the GNSS satisfies a first threshold strength level. The signal strength for a GNSS signal is typically identified by measuring the power level of the signals received from satellites. This measurement is often represented in decibels relative to a reference level (dBm). A stronger signal, indicated by higher dBm values, suggests better reception quality and typically correlates with more accurate positioning data, whereas lower signal strengths can lead to degraded accuracy and may require additional signal processing or antenna adjustments to improve reception. In this regard, the first threshold strength level can be static or dynamic in nature (e.g., −130 dBm). It is noted that the foregoing examples are not meant to be limiting, and that the wireless device 102 can be configured to analyze any amount, type, form, etc., of location information, at any level of granularity, to effectively identify an overall strength of GNSS signals observed by the wireless device 102, consistent with the scope of this disclosure.

The wireless device 102 can also identify the environmental state 406 by (2)(ii) determining, based on the cellular signal information, that at least one cellular signal observed by the wireless device satisfies a second threshold strength level. The signal strength for a cellular signal is typically identified by measuring the power level of the signals received from cellular base stations, repeaters, etc. As with GNSS signals, a stronger cellular signal, indicated by higher dBm values, suggests better reception quality, whereas lower signal strengths suggest poorer reception quality. In this regard, the second threshold strength level can be static or dynamic in nature (e.g., −100 dBm). It is noted that the foregoing examples are not meant to be limiting, and that the wireless device 102 can be configured to analyze any amount, type, form, etc., of cellular signal information, at any level of granularity, to effectively identify an overall strength of cellular signals observed by the wireless device 102, consistent with the scope of this disclosure.

The wireless device 102 can also identify the environmental state 406 by (2)(iii) determining, based on the payment transaction information, that a payment transaction associated with a subway station entry was performed within a threshold period of time (relative to the current time). To identify a transaction that corresponds to a subway system, several key indicators can be considered. For example, merchant names or descriptors can be analyzed to identify transit agencies, ticket vending machines, or service providers directly associated with transit services. In another example, analyzing transaction amounts and frequencies can be informative, as payments for transit typically reflect specific fare amounts or recurring passes. In yet another example, geographic data associated with transactions can be utilized to identify purchases, transactions, etc., that occur at transit stations, ticket counters, or on transit vehicles. In yet another example, transaction codes or categories used by financial institutions may categorize these transactions under “transportation”, “transit”, etc., thereby aiding in identification. It is noted that the foregoing examples are not meant to be limiting, and that the wireless device 102 can be configured to analyze any amount, type, form, etc., of payment information, at any level of granularity, to effectively identify whether a transit-related transaction took place within a threshold period of time (e.g., within thirty seconds before the current time), consistent with the scope of this disclosure.

The wireless device 102 can also identify the environmental state 406 by (2)(iv) determining, based on the Wi-Fi signal information, that at least one detected service set identifier (SSID) matches an SSID known to be associated with a subway station. One approach for determining whether the wireless device 102 is within a subway station using Wi-Fi information can involve analyzing the unique characteristics of Wi-Fi networks in transit environments. In particular, Wi-Fi network names, known as SSIDs, often include identifiers specific to subway stations, which can aid in direct identification when connecting to, scanning for, etc., available Wi-Fi networks. Under one approach, one or more of the detected SSIDs can be assigned a respective probability value (e.g., using machine learning approaches, rules-based approaches, etc.) that indicates a likelihood of the SSID corresponding to a subway station. Under another approach, one or more of the detected SSIDs can be cross-referenced against a list of SSIDs known to be associated with subway stations.

It should be appreciated that other Wi-Fi information (in addition to, aside from, etc., the SSID information) can be analyzed by the wireless device 102. For example, the wireless device 102 can be configured to monitor Wi-Fi signal strength and coverage patterns to identify proximity to subway station areas, given devices closer to entrances or within stations typically exhibit stronger signals from station Wi-Fi networks compared to those outside. Location-based services (LBS) utilizing Wi-Fi access points as reference points can also be used to further-refine location accuracy within subway station confines. Moreover, databases that map Wi-Fi access point locations can facilitate the identification of known subway station Wi-Fi networks by cross-referencing detected networks with their geographic coordinates. It is noted that the foregoing examples are not meant to be limiting, and that the wireless device 102 can analyze any amount, type, form, etc., of Wi-Fi information, at any level of granularity, consistent with the scope of this disclosure.

As shown in FIG. 4A, an event 407 involves the wireless device 102 entering a train, which ultimately results in an environmental state 408 where the wireless device 102 is on a train. According to some embodiments, the wireless device 102 can identify the environmental state 408 by determining, based on the motion information, that a motion of the wireless device 102 sufficiently matches a train movement profile (e.g., using machine learning approaches, rules-based approaches, etc.). In one example, the wireless device 102 can monitor changes in acceleration along different axes (X, Y, and/or Z) to distinguish the distinct movements associated with train travel, such as acceleration, deceleration, and lateral motion. These patterns differ significantly from the motions observed during walking or stationary activities, and can thereby be exploited by the wireless device 102 to clearly identify when train travel is taking place. Additionally, wireless device 102 can be configured to detect the characteristic vibrations and oscillations generated by trains as they move along tracks, which are distinct from the smoother movements typical of other forms of transport (e.g., airplanes). It is noted that the foregoing examples are not meant to be limiting, and that the wireless device 102 can analyze any amount, type, form, etc., of information (e.g., motion information, sound information, etc.), at any level of granularity, to effectively identify whether the wireless device 102 is on a train, consistent with the scope of this disclosure.

As shown in FIG. 4A, an event 409 involves the wireless device 102 exiting the train, which ultimately results in an environmental state 410 where the wireless device 102 is in a subway station (presumably one different from the subway station discussed above in conjunction with environmental states 402, 404, and 406, assuming the train has traveled to another station). According to some embodiments, the wireless device 102 can identify the environmental state 410 by determining, based on the motion information, that a motion of the wireless device 102 insufficiently matches a train movement profile. For example, the wireless device 102 can detect that the motion has transitioned from matching a train profile to matching a walking/running profile, a staircase profile, an escalator profile, an elevator profile, etc. The wireless device 102 can also identify the environmental state 410 by performing the same (or similar) analyses described above in conjunction with identifying the environmental state 406 to effectively identify that the wireless device 102 is in a subway station.

As shown in FIG. 4A, an event 411 involves the wireless device 102 exiting the subway station, which ultimately results in an environmental state 412 where the wireless device 102 is near a subway station. According to some embodiments, the wireless device 102 can identify the environmental state 412 by (1) determining, based on the altitude information and the ground elevation, that the wireless device 102 is disposed above the ground elevation (e.g., using the same or similar analyses described above in conjunction with identifying the environmental state 404), and (2)(i) determining, based on the location information, that at least one signal associated with the GNSS satisfies a first threshold strength level (e.g., using the same or similar analyses described above in conjunction with identifying the environmental state 404), (2)(ii) determining, based on the cellular signal information, that at least one cellular signal observed by the wireless device satisfies a second threshold strength level (e.g., using the same or similar analyses described above in conjunction with identifying the environmental state 404), (2)(iii) determining, based on the payment transaction information, that a payment transaction associated with a subway station exit was performed within a threshold period of time (e.g., using the same or similar analyses described above in conjunction with identifying the environmental state 404), (2)(iv) determining, based on the Wi-Fi signal information, that detected service set identifiers (SSIDs) fail to match any SSIDs known to be associated with a subway station (e.g., using the same or similar analyses described above in conjunction with identifying the environmental state 404), or (2)(v) any combination thereof.

As shown in FIG. 4A, an event 413 involves the wireless device 102 leaving a subway station area, which ultimately results in an environmental state 414 where the wireless device 102 is away from a subway station. According to some embodiments, the wireless device 102 can identify the environmental state 414 by performing the same (or similar) analyses described above in conjunction with identifying the environmental state 402.

Accordingly, FIG. 4A—as well as FIG. 4B—illustrate conceptual diagrams 400, 450 of an example scenario of the wireless device 102 undergoing environmental state transitions. According to some embodiments, the wireless device 102 can be configured to perform different operations, actions, etc., in response to detecting environmental states, transitions therebetween, and so on.

In one example, the wireless device 102 can be configured to deactivate, modify, etc., cellular operations, Wi-Fi operations, Bluetooth operations, Near Field Communication (NFC) operations, etc. In another example, the wireless device 102 can be configured to perform at least one advanced download of information, such as digital media content, transit information, emails, documents, etc., so that the information can be accessed in the event that Internet access for the wireless device 102 degrades or becomes unavailable. In another example, the wireless device 102 can provide, to one or more server computing devices, an indication of the environmental state transition or transition (assuming a user of the wireless device 102 has provided permission to do so). In turn, the server computing devices can utilize the information to perform agent-based modeling procedures, discrete event simulation procedures, pedestrian dynamics modeling procedures, etc., to identify useful patterns, behaviors, etc., that can be used to optimize different aspects of subway infrastructures (e.g., layout, cellular/Wi-Fi station locations, etc.).

It is noted that the foregoing examples are not meant to be limiting, and that the wireless device 102 can perform any amount, type, form, etc., of operation(s), at any level of granularity, consistent with the scope of this disclosure, in response to detecting an environmental state, a transition therebetween, etc. It should also be appreciated that different environmental states, transitions therebetween, etc., can be associated with respective additional conditions that must be satisfied prior to the wireless device 102 taking action, such as waiting for threshold periods of time to pass (to prevent thrashing scenarios), analyzing additional information to make additional determinations, and so on. It should further be appreciated that the determinations, actions, respective additional conditions, etc., can be user-defined so that users can custom-tailor how their wireless devices 102 respond to environmental states, changes therebetween, etc.

Additionally, it is noted that the various techniques provided herein can be overridden by a user at any time regardless of state in which the wireless device 102 is operating. For example, when the wireless device 102 determines that it is prudent to adjust, deactivate, etc., communications components (e.g., cellular, Wi-Fi, etc.), the user can still cause the communications components to operate in accordance with the user's preferences. This can be particularly useful in emergency situations where the user would be benefit from the possibility of the wireless device 102 successfully connecting to available services.

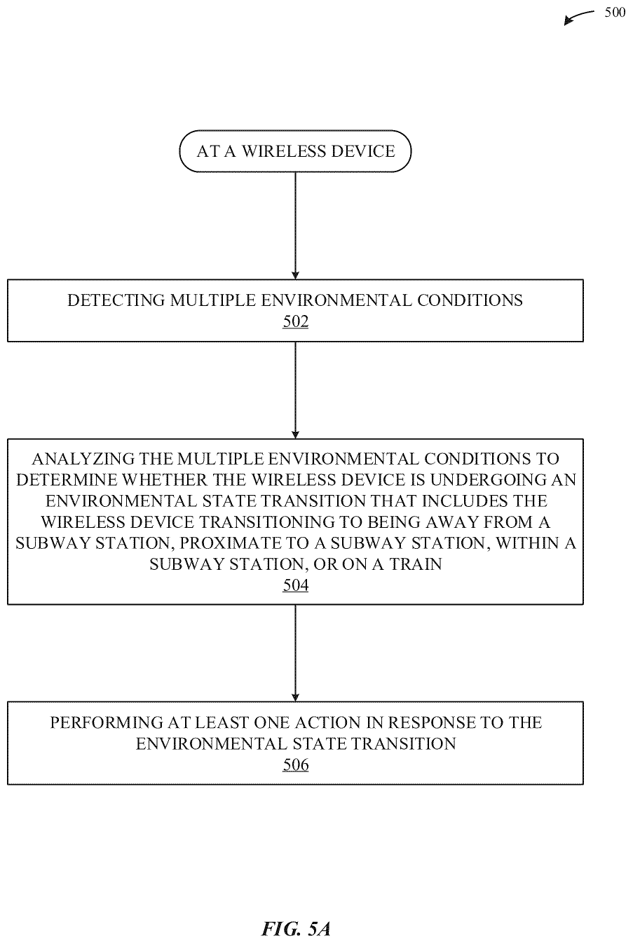

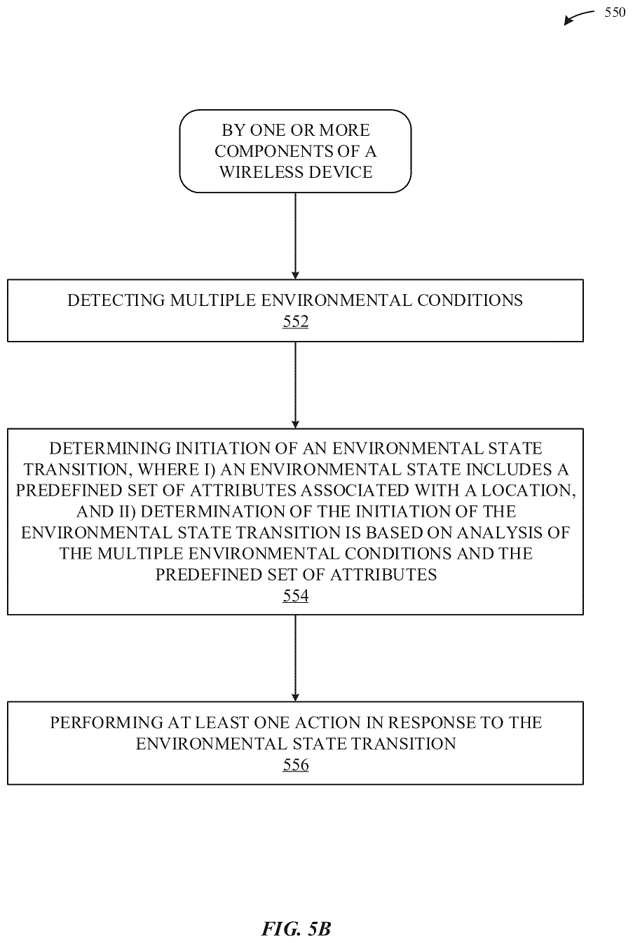

FIG. 5A illustrates an exemplary method 500 for responding to environmental state transitions experienced by a wireless device 102, according to some embodiments. As shown in FIG. 5A, the method 500 begins at step 502, where the wireless device 102 detects multiple environmental conditions (e.g., as described herein in conjunction with FIGS. 1-4).

At step 504, the wireless device 102 analyzes the multiple environmental conditions to determine whether the wireless device 102 is undergoing an environmental state transition that includes the wireless device 102 transitioning to being away from a subway station, proximate to a subway station, within a subway station, or on a subway train (e.g., as described above in conjunction with FIGS. 1-4).

At step 506, the wireless device 102 performs at least one action in response to the environmental state transition (e.g., as described herein in conjunction with FIGS. 1-4).

FIG. 5B illustrates another exemplary method 550 for responding to environmental state transitions experienced by a wireless device 102, according to some embodiments. As shown in FIG. 5B, the method 550 begins at step 552, where one or more components of the wireless device 102 detect multiple environmental conditions (e.g., as described herein in conjunction with FIGS. 1-4).

At step 554, the one or more components of the wireless device 102 determine initiation of an environmental state transition, where an environmental state includes a predefined set of attributes associated with a location, and determination of the initiation of the environmental state transition is based on analysis of the multiple environmental conditions and the predefined set of attributes (e.g., as described herein in conjunction with FIGS. 1-4).

At step 556, the one or more components of the wireless device 102 perform at least one action in response to the environmental stat transition (e.g., as described herein in conjunction with FIGS. 1-4).

### Exemplary Embodiments

In an exemplary embodiment, a method for responding to environmental state transitions experienced by a wireless device includes one or more components of the wireless device: (1) detecting multiple environmental conditions; (2) determining initiation of an environmental state transition, where (i) an environmental state includes a predefined set of attributes associated with a location, and (ii) determination of the initiation of the environmental state transition is based on analysis of the multiple environmental conditions and the predefined set of attributes; and (3) performing at least one action in response to the environmental state transition.

According to some embodiments, the location includes a train station, and the predefined set of attributes include proximity information associated with the train station and/or a train.

According to some embodiments, the multiple environmental conditions include: (i) location information associated with the wireless device, wherein the location information includes a position of the wireless device obtained through at least one global navigation satellite system (GNSS), mapping-based transit information that identifies train station locations relative to the position of the wireless device, mapping-based elevation information that identifies a ground elevation relative to the position of the wireless device, or any combination thereof, (ii) altitude information associated with the wireless device, (iii) cellular signal information observed by the wireless device, (iv) motion information observed by the wireless device, (v) payment transaction information observed by the wireless device, (vi) Wi-Fi signal information observed by the wireless device, or (vii) any combination thereof.

According to some embodiments, an accuracy rating of the position is based on a horizontal dilution of precision (HDOP), a vertical dilution of precision (VDOP), a position dilution of precision (PDOP), an estimated position error (EPE), a number of satellites, a signal-to-noise ratio (SNR), or any combination thereof.

According to some embodiments, determination of the initiation of the environmental state transition includes a determination that the wireless device is transitioning from being away from the train station to being proximate to the train station based at least in part on: (i) determining that the accuracy rating of the position satisfies a threshold level, and (ii) determining, based on the position and the mapping-based transit information, that the wireless device is within a threshold distance to a closest train station.

According to some embodiments, determination of the initiation of the environmental state transition includes a determination that the wireless device is transitioning from being proximate to the subway station to being away from the subway station based at least in part on: (i) determining that the accuracy rating of the position satisfies a threshold level, and (ii) determining, based on the position and the mapping-based transit information, that the wireless device is not within a threshold distance to a closest subway station.

According to some embodiments, determination of the initiation of the environmental state transition includes a determination that the wireless device is transitioning from being proximate to the subway station to being within the subway station based at in part on: (1) determining, based on the altitude information and the ground elevation, that the wireless device is disposed lower than the ground elevation, and (2)(i) determining, based on the location information, that at least one signal associated with the GNSS satisfies a first threshold strength level, (ii) determining, based on the cellular signal information, that at least one cellular signal observed by the wireless device satisfies a second threshold strength level, (iii) determining, based on the payment transaction information, that a payment transaction associated with a subway station entry was performed within a threshold period of time, (iv) determining, based on the Wi-Fi signal information, that at least one detected service set identifier (SSID) matches an SSID known to be associated with a subway station, or (v) any combination thereof.

According to some embodiments, determination of the initiation of the environmental state transition includes a determination that the wireless device is transitioning from being within the subway station to being proximate to the subway station based at least in part on: (1) determining, based on the altitude information and the ground elevation, that the wireless device is disposed above the ground elevation, and (2)(i) determining, based on the location information, that at least one signal associated with the GNSS satisfies a first threshold strength level, (ii) determining, based on the cellular signal information, that at least one cellular signal observed by the wireless device satisfies a second threshold strength level, (iii) determining, based on the payment transaction information, that a payment transaction associated with a subway station exit was performed within a threshold period of time, (iv) determining, based on the Wi-Fi signal information, that detected service set identifiers (SSIDs) fail to match any SSIDs known to be associated with a subway station, or (v) any combination thereof.

According to some embodiments, determination of the initiation of the environmental state transition includes a determination that the wireless device is transitioning from being within the subway station to being on the train based at least in part on: determining, based on the motion information, that a motion of the wireless device sufficiently matches a train movement profile, where the train movement profile includes respective accelerations across all axes.

According to some embodiments, determination of the initiation of the environmental state transition includes a determination that the wireless device is transitioning from being on the train to being within the subway station based at least in part on: determining, based on the motion information, that a motion of the wireless device insufficiently matches a train movement profile, where the train movement profile includes respective accelerations across all axes.

According to some embodiments, adjusting at least one operational aspect of the wireless device based on the environmental state transition includes: (i) modifying at least one operational aspect of a baseband component of the wireless device, (ii) modifying at least one operational aspect of a Wi-Fi component of the wireless device, (iii) performing at least one advanced download of information, (iv) providing, to a server computing device, an indication of the environmental state transition or transition, or (v) any combination thereof.

### Exemplary Computing Device

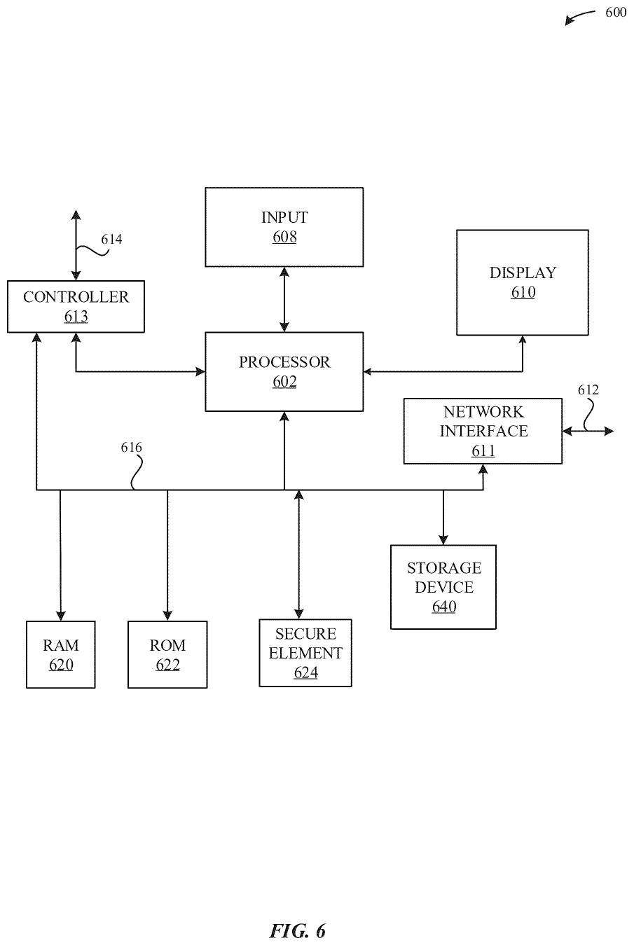

FIG. 6 illustrates a detailed view of a representative computing device 600 that can be used to implement various methods described herein, according to some embodiments. In particular, the detailed view illustrates various components that can be included in a wireless device 102. As shown in FIG. 6, the computing device 600 can include a processor 602 that represents a microprocessor or controller for controlling the overall operation of computing device 600. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of sensor data, etc. Still further, the computing device 600 can include a display 610 that can be controlled by the processor 602 to display information to the user. A data bus 616 can facilitate data transfer between at least a storage device 640, the processor 602, and a controller 613. The controller 613 can be used to interface with and control different equipment through an equipment control bus 614. The computing device 600 can also include a network/bus interface 611 that communicatively couples to a data link 612. In the case of a wireless connection, the network/bus interface 611 can include a wireless transceiver.

The computing device 600 also includes a storage device 640, which can include a single disk or multiple disks (e.g., hard drives), and includes a storage management module that manages one or more partitions within the storage device 640. In some embodiments, storage device 640 can include flash memory, semiconductor (solid state) memory or the like. The computing device 600 can also include a Random Access Memory (RAM) 620 and a Read-Only Memory (ROM) 622. The ROM 622 can store programs, utilities, or processes to be executed in a non-volatile manner. The RAM 620 can provide volatile data storage, and stores instructions related to the operation of the computing device 600. The computing device 600 can further include a secure element (SE) 624, such as an cUICC 108, a UICC 118, or another secure storage for cellular wireless system access by a wireless device 102.

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High-Speed Packet Access (HSPA+) network or a Code Division Multiple Access (CDMA) 2000. Evolution-Data Only (EV-DO) network, when LTE and LTE-A networks are otherwise unavailable.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for responding to environmental state transitions experienced by a wireless device, the method comprising, by one or more components of the wireless device:
detecting a plurality of environmental conditions;
determining initiation of an environmental state transition, wherein:
an environmental state comprises a predefined set of attributes associated with a location; and
determination of the initiation of the environmental state transition is based on analysis of the plurality of environmental conditions and the predefined set of attributes; and
performing at least one action in response to the environmental state transition.

2. The method of claim 1, wherein:
the location comprises a train station; and
the predefined set of attributes comprise proximity information associated with the train station and/or a train.

3. The method of claim 2, wherein the plurality of environmental conditions include at least two of:
location information associated with the wireless device, wherein the location information comprises a position of the wireless device obtained through at least one global navigation satellite system (GNSS), mapping-based transit information that identifies train station locations relative to the position of the wireless device, mapping-based elevation information that identifies a ground elevation relative to the position of the wireless device, or any combination thereof;
altitude information associated with the wireless device;
cellular signal information observed by the wireless device;
motion information observed by the wireless device;
payment transaction information observed by the wireless device;
Wi-Fi signal information observed by the wireless device; or
any combination thereof.

4. The method of claim 3, wherein an accuracy rating of the position is based on a horizontal dilution of precision (HDOP), a vertical dilution of precision (VDOP), a position dilution of precision (PDOP), an estimated position error (EPE), a number of satellites, a signal-to-noise ratio (SNR), or any combination thereof.

5. The method of claim 4, wherein determination of the initiation of the environmental state transition comprises a determination that the wireless device is transitioning from being away from the train station to being proximate to the train station based at least in part on:
determining that the accuracy rating of the position satisfies a threshold level, and
determining, based on the position and the mapping-based transit information, that the wireless device is within a threshold distance to a closest train station.

6. The method of claim 4, wherein determination of the initiation of the environmental state transition comprises a determination that the wireless device is transitioning from being proximate to the train station to being away from the train station based at least in part on:
determining that the accuracy rating of the position satisfies a threshold level, and
determining, based on the position and the mapping-based transit information, that the wireless device is not within a threshold distance to a closest train station.

7. The method of claim 3, wherein determination of the initiation of the environmental state transition comprises a determination that the wireless device is transitioning from being proximate to the train station to being within the train station based at least in part on:
determining, based on the altitude information and the ground elevation, that the wireless device is disposed lower than the ground elevation, and
determining, based on the location information, that at least one signal associated with the GNSS satisfies a first threshold strength level,
determining, based on the cellular signal information, that at least one cellular signal observed by the wireless device satisfies a second threshold strength level,
determining, based on the payment transaction information, that a payment transaction associated with a train station entry was performed within a threshold period of time,
determining, based on the Wi-Fi signal information, that at least one detected service set identifier (SSID) matches an SSID known to be associated with a train station, or
any combination thereof.

8. The method of claim 3, wherein determination of the initiation of the environmental state transition comprises a determination that the wireless device is transitioning from being within the train station to being proximate to the train station based at least in part on:
determining, based on the altitude information and the ground elevation, that the wireless device is disposed above the ground elevation, and
determining, based on the location information, that at least one signal associated with the GNSS satisfies a first threshold strength level,
determining, based on the cellular signal information, that at least one cellular signal observed by the wireless device satisfies a second threshold strength level,
determining, based on the payment transaction information, that a payment transaction associated with a train station exit was performed within a threshold period of time,
determining, based on the Wi-Fi signal information, that detected service set identifiers (SSIDs) fail to match any SSIDs known to be associated with a train station, or
any combination thereof.

9. The method of claim 3, wherein determination of the initiation of the environmental state transition comprises a determination that the wireless device is transitioning from being within the train station to being on the train based at least in part on:
determining, based on the motion information, that a motion of the wireless device sufficiently matches a train movement profile, wherein the train movement profile comprises respective accelerations across all axes.

10. The method of claim 3, wherein determination of the initiation of the environmental state transition comprises a determination that the wireless device is transitioning from being on the train to being within the train station based at least in part on:
determining, based on the motion information, that a motion of the wireless device insufficiently matches a train movement profile, wherein the train movement profile comprises respective accelerations across all axes.

11. The method of claim 1, wherein performing the at least one action in response to the environmental state transition comprises:
modifying at least one operational aspect of a baseband component of the wireless device,
modifying at least one operational aspect of a Wi-Fi component of the wireless device,
performing at least one advanced download of information,
providing, to a server computing device, an indication of the environmental state transition or transition, or
any combination thereof.

12. An apparatus configured to respond to environmental state transitions experienced by a wireless device, the apparatus comprising at least one processor communicatively coupled to at least one memory storing instructions, the apparatus configured to:
detect a plurality of environmental conditions;
determine initiation of an environmental state transition, wherein:
an environmental state comprises a predefined set of attributes associated with a location; and
determination of the initiation of the environmental state transition is based on analysis of the plurality of environmental conditions and the predefined set of attributes; and
perform at least one action in response to the environmental state transition.

13. The apparatus of claim 12, wherein:
the location comprises a train station; and
the predefined set of attributes comprise proximity information associated with the train station and/or a train.

14. The apparatus of claim 12, wherein the plurality of environmental conditions include at least two of:
location information associated with the wireless device, wherein the location information comprises a position of the wireless device obtained through at least one global navigation satellite system (GNSS), mapping-based transit information that identifies train station locations relative to the position of the wireless device, mapping-based elevation information that identifies a ground elevation relative to the position of the wireless device, or any combination thereof,
altitude information associated with the wireless device,
cellular signal information observed by the wireless device,
motion information observed by the wireless device,
payment transaction information observed by the wireless device,
Wi-Fi signal information observed by the wireless device, or
any combination thereof.

15. The apparatus of claim 14, wherein determination of the initiation of the environmental state transition comprises a determination that the wireless device is transitioning from being away from the train station to being proximate to the train station based at least in part on:
determining that an accuracy rating of the position satisfies a threshold level, and
determining, based on the position and the mapping-based transit information, that the wireless device is within a threshold distance to a closest train station.

16. The apparatus of claim 14, wherein determination of the initiation of the environmental state transition comprises a determination that the wireless device is transitioning from being proximate to the train station to being away from the train station based at least in part on:
determining that an accuracy rating of the position satisfies a threshold level, and
determining, based on the position and the mapping-based transit information, that the wireless device is not within a threshold distance to a closest train station.

17. The apparatus of claim 14, wherein determination of the initiation of the environmental state transition comprises a determination that the wireless device is transitioning from being proximate to the train station to being within the train station based at least in part on:
determining, based on the altitude information and the ground elevation, that the wireless device is disposed lower than the ground elevation, and
determining, based on the location information, that at least one signal associated with the GNSS satisfies a first threshold strength level,
determining, based on the cellular signal information, that at least one cellular signal observed by the wireless device satisfies a second threshold strength level,
determining, based on the payment transaction information, that a payment transaction associated with a train station entry was performed within a threshold period of time,
determining, based on the Wi-Fi signal information, that at least one detected service set identifier (SSID) matches an SSID known to be associated with a train station, or
any combination thereof.

18. The apparatus of claim 14, wherein determination of the initiation of the environmental state transition comprises a determination that the wireless device is transitioning from being within the train station to being proximate to the train station based at least in part on:
determining, based on the altitude information and the ground elevation, that the wireless device is disposed above the ground elevation, and
determining, based on the location information, that at least one signal associated with the GNSS satisfies a first threshold strength level,
determining, based on the cellular signal information, that at least one cellular signal observed by the wireless device satisfies a second threshold strength level,
determining, based on the payment transaction information, that a payment transaction associated with a train station exit was performed within a threshold period of time,
determining, based on the Wi-Fi signal information, that detected service set identifiers (SSIDs) fail to match any SSIDs known to be associated with a train station, or any combination thereof.

19. The apparatus of claim 12, wherein performance of the at least one action in response to the environmental state transition comprises:
modifying at least one operational aspect of a baseband component of the wireless device,
modifying at least one operational aspect of a Wi-Fi component of the wireless device,
performing at least one advanced download of information,
providing, to a server computing device, an indication of the environmental state transition or transition, or
any combination thereof.

20. A non-transitory computer-readable medium storing instructions for responding to environmental state transitions, the instructions comprising:
instructions for detecting a plurality of environmental conditions;
instructions for determining initiation of an environmental state transition, wherein:
an environmental state comprises a predefined set of attributes associated with a location; and
determination of the initiation of the environmental state transition is based on analysis of the plurality of environmental conditions and the predefined set of attributes; and
instructions for performing at least one action in response to the environmental state transition.
